(19) United States
(12) Patent Application Publication
(10) Pub. No.: US 2020/0226008 A1
(43) Pub. Date: Jul. 16, 2020

(54) INFORMATION PASTING METHOD AND APPARATUS, ELECTRONIC DEVICE AND STORAGE MEDIUM

(71) Applicant: NETEASE (HANGZHOU) NETWORK CO.,LTD., Hangzhou (CN)

(72) Inventor: Qiqi GU, Hangzhou (CN)

(73) Assignee: NETEASE (HANGZHOU) NETWORK CO.,LTD., Hangzhou (CN)

(21) Appl. No.: 16/836,107

(22) Filed: Mar. 31, 2020

Related U.S. Application Data
(63) Continuation-in-part of application No. PCT/CN2019/076198, filed on Feb. 26, 2019.

(30) Foreign Application Priority Data
Mar. 19, 2018 (CN) 201810226654.4

(51) Int. Cl. G06F 9/54; G06F 3/0482; G06F 3/0484; G06F 3/0488

(52) U.S. Cl. CPC G06F 9/543; G06F 3/04886; G06F 3/04842; G06F 3/0482

(57) ABSTRACT

Provided are an information pasting method, an information pasting apparatus, an electronic device and a computer-readable storage medium. The method includes: in response to a preset operation, displaying one or a plurality of paste controls on the interactive interface; and when a paste operation for at least one of the paste controls is received, pasting preset information corresponding to the preset operation at a predetermined position on the interactive interface.

### TECHNICAL FIELD

The present disclosure relates to computer technologies, and in particular, to an information pasting method, an information pasting device, an electronic device, and a computer-readable storage medium.

### BACKGROUND

With the development of computer application technologies, people are increasingly processing daily information through mobile terminals. Copy and paste is an operation often used by people, and the complexity or simplicity of the implementation process has a great influence on the time and energy that people spend when editing information.

When pasting information on a touch terminal, since shortcut keys cannot be used like on a computer, users usually need multiple touch operations to complete the paste operation, which is a tedious process. Therefore, it is necessary to propose a simple method for pasting information.

It should be noted that the information disclosed in the background section above is only used to enhance the understanding of the background of the present disclosure, and therefore may include information that does not constitute the prior art known to those skilled in the art.

### SUMMARY

The present disclosure provides an information pasting method, an information pasting device, an electronic device and a computer-readable storage medium, so as to at least to some extent addressing the problem of the tedious pasting operation process on a touch terminal due to limitations and defects of the prior art.

Other features and advantages of the present disclosure will become apparent from the following detailed description, or may be learned in part through the practice of the present disclosure.

According to an aspect of the present disclosure, there is provided an information pasting method, applied to a touch terminal for presenting an interactive interface, the method comprising:

in response to a preset operation, displaying one or a plurality of paste controls on the interactive interface; and

when a paste operation for at least one of the paste controls is received, pasting preset information corresponding to the preset operation at a predetermined position on the interactive interface.

According to an aspect of the present disclosure, there is provided an information pasting device, applied to a touch terminal for presenting an interactive interface, the device comprising:

a preset operation response module configured to, in response to a preset operation, display one or a plurality of paste controls on the interactive interface; and

a paste operation response module configured to, when a paste operation for at least one of the paste controls is received, paste preset information corresponding to the preset operation at a predetermined position on the interactive interface.

According to an aspect of the present disclosure, there is provided an electronic device, comprising:

a processor; and

a memory for storing instructions executable by the processor;

wherein when the instructions are executed by the processor, the processor is caused to implement the method according to any one of the above aspects.

According to an aspect of the present disclosure, there is provided a computer-readable storage medium having stored thereon computer programs which, when executed by a processor, implement the method according to any one of the above aspects.

It should be understood that the above general description and the following detailed description are merely exemplary and explanatory, and should not limit the present disclosure.

### BRIEF DESCRIPTION OF THE DRAWINGS

The drawings herein are incorporated in and constitute a part of the specification, illustrate embodiments consistent with the present disclosure, and together with the description serve to explain the principles of the present disclosure. Obviously, the drawings in the following description are only some embodiments of the present disclosure. For those of ordinary skill in the art, other drawings can be obtained based on these drawings without departing from the spirit of the present disclosure.

FIG. 1 schematically illustrates the process of a copy and paste operation in the related art.

FIG. 2 schematically illustrates a flowchart of an information pasting method according to an exemplary embodiment of the present disclosure.

FIG. 3 schematically illustrates a schematic diagram of an information paste interaction interface according to an exemplary embodiment of the present disclosure.

FIG. 4 schematically illustrates another information pasting interaction interface according to an exemplary embodiment of the present disclosure.

FIG. 5 schematically illustrates another information pasting interaction interface according to an exemplary embodiment of the present disclosure.

FIG. 6 schematically illustrates a structural block diagram of an information pasting device according to an exemplary embodiment of the present disclosure.

FIG. 7 schematically illustrates an electronic device for implementing the above methods according to an exemplary embodiment of the present disclosure.

FIG. 8 schematically illustrates a computer-readable storage medium for implementing the above methods according to an exemplary embodiment of the present disclosure.

### DETAILED DESCRIPTION

Example embodiments will now be described more fully with reference to the accompanying drawings. However, the exemplary embodiments can be implemented in various forms and should not be construed as limited to the examples set forth herein; rather, providing these embodiments makes the present disclosure more comprehensive and complete, and conveys the concepts of the exemplary embodiments comprehensively to those skilled in the art. The described features, structures, or characteristics may be combined in any suitable manner in one or more embodiments.

In addition, the drawings are merely schematic illustrations of the present disclosure and are not necessarily drawn to scale. The same reference numerals in the drawings represent the same or similar parts, and thus repeated descriptions thereof will be omitted. Some block diagrams shown in the drawings are functional entities and do not necessarily correspond to physically or logically independent entities. These functional entities may be implemented in the form of software, or implemented in one or more hardware modules or integrated circuits, or implemented in different networks and/or processor devices and/or microcontroller devices.

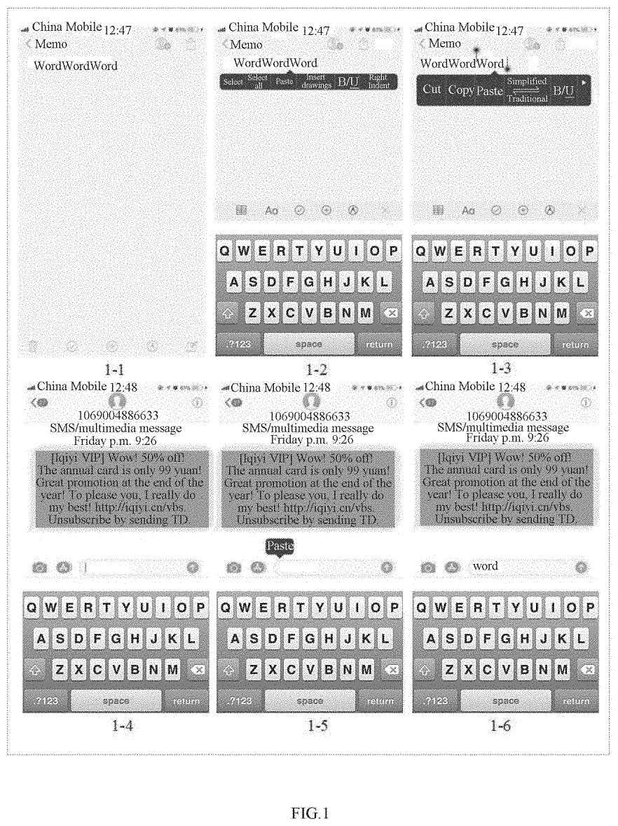

In related art, referring to FIG. 1, the process of copy and paste operation on a touch terminal is usually as follows. A user first long presses the text to trigger the selection state (see 1-2 in FIG. 1), selects the text to be copied, and clicks a Copy option to perform the copy operation (see 1-3 in FIG. 1). The user taps a text box to activate the input state when pasting (see 1-4 in FIG. 1), performs a long-press operation to trigger to display the paste option (see 1-5 in FIG. 1), and taps the paste option to perform the paste operation (see 1-6 in FIG. 1). It can be seen that the copy operation requires three steps, and the paste operation also requires three steps. The entire process is very tedious, which increases the operation time for the user to edit the information, and the user can only paste the latest copied information, causing inconvenience to the user.

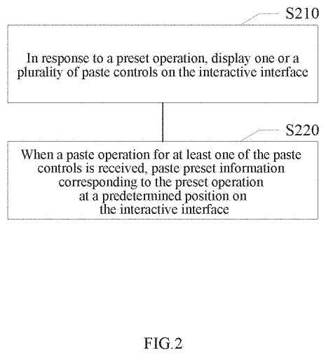

In view of the above problems, an exemplary embodiment of the present disclosure first provides an information pasting method, which can be applied to a touch terminal that presents an interactive interface. The touch terminal may be a device with a touch screen, such as a smart phone, a tablet computer, a portable game machine, a Personal Digital Assistant (PDA), and so on. The interactive interface may be an entire displayable area of the touch terminal, such as a full screen displayed on the touch terminal. Alternatively, the interactive interface may be a partial displayable area of the touch terminal, such as a window on the touch terminal. As shown in FIG. 2, the method for pasting information may include the following steps:

In step S210, in response to a preset operation, one or a plurality of paste controls are displayed on the interactive interface.

In step S220, when a paste operation for at least one of the paste controls is received, preset information corresponding to the preset operation is pasted at a predetermined position on the interactive interface.

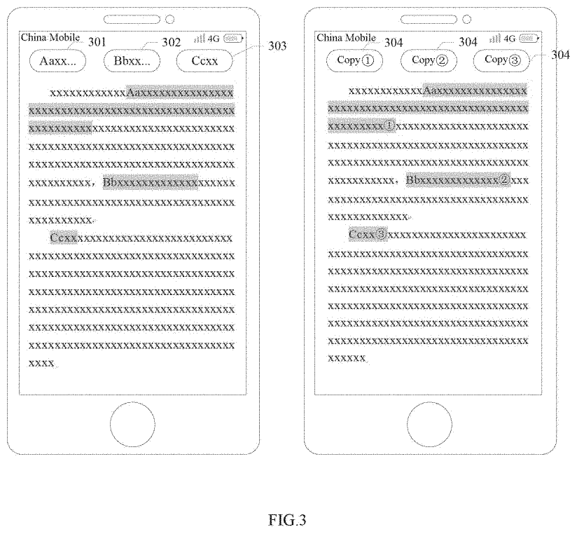

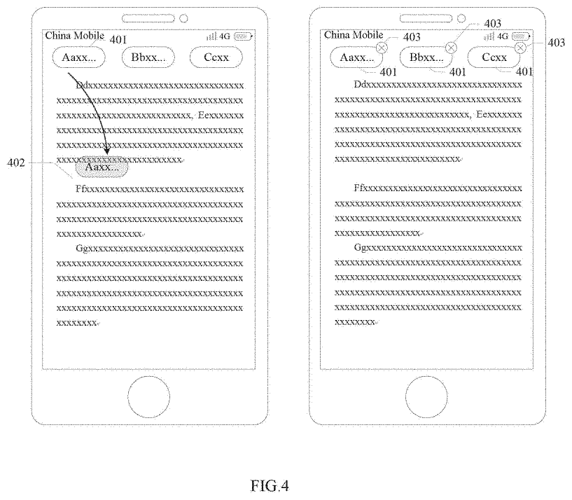

The preset operation may be a copy operation or a cut operation, and the copy operation and the cut operation may be the same as the existing operation methods. For example, the copy operation may be as follows: a user long-presses information to trigger a selection state to select an information field to be copied, taps the copy option to copy the information. The preset information refers to target information that a user needs to copy or cut. After the user selects the preset information and selects the copy option, the terminal can display a paste control on the interactive interface. The paste control is an operable control that has a specific association with the preset information. In an exemplary embodiment, the paste control may at least partially display the preset information corresponding to the paste control. For example, the paste control (301, 302, 303) in FIG. 3 includes a preview of the preset information (such as Aaxx, Bbxx, Ccxx). In addition, the paste control may also be in the form of a floating mark which is identified by specific words, such as copy \textcircled{1}, copy \textcircled{2}, and copy \textcircled{3} as shown in 304 in FIG. 3, or the paste control may be in other forms. The predetermined position refers to a target position where the user needs to paste the preset information, and can generally be determined by a paste operation. In an exemplary embodiment, the paste operation for at least one of the paste controls may be dragging the at least one of paste controls to the predetermined position, as shown in FIG. 4. After the user drag the paste control 401 to the predetermined position 402, the preset information corresponding to the paste control 401 can be displayed at the predetermined position 402. In another exemplary embodiment, the paste operation can also be performed by selecting a predetermined position and tapping the paste control. After the user performs the paste operation, the terminal can paste the preset information at the predetermined position.

In exemplary embodiments of the present disclosure, the touch terminal displays the paste control(s) on the interactive interface after receiving the user's copy or cut operation, and pastes the preset information corresponding to the paste control(s) at the predetermined position after receiving the user's paste operation. On the one hand, the user can paste the preset information at the predetermined position through the paste operation on the paste control. This operation only includes one (for example, dragging the paste control to the predetermined position) or two steps (for example, selecting the predetermined position and tapping the paste control), while the paste operation in the related art requires three or more steps. Thus, the methods according to embodiments of the present disclosure reduces the number of operation steps compared with the related art, and can save a user's operation time for editing information. On the other hand, contents related to the preset information can be displayed on the paste control, so that the user can visually or directly see the contents when performing the paste operation, thereby reducing wrong or careless operations when the user pastes information, and improving user experience.

Referring to FIG. 3 described above, there may be multiple paste controls on the interactive interface. In an exemplary embodiment, displaying one or a plurality of paste controls on the interactive interface comprises: displaying a plurality of paste controls on the interactive interface, wherein any one of the plurality of paste controls corresponds to a preset operation and preset information. Taking FIG. 3 as an example, when the user selects the text of “Aaxx . . . ” and selects the copy option, the first paste control 301 is displayed on the interactive interface; when the user selects the text of “Bbxx . . . ” and selects the copy option, the second paste control 302 is displayed on the interactive interface, and so on, and the third paste control 303 and more paste controls can be displayed. In this embodiment, the user can copy multiple pieces of preset information at the same time and selectively paste information according to actual needs in the paste operation, which solves the problem that the user can only paste the latest copied information in the related art. Thus, the present disclosure makes the user operation more convenient.

In an exemplary embodiment, the method may further include: when a cancel operation for the at least one of the paste controls is received, removing the at least one of the paste controls from the interactive interface. The cancel operation may be a long-press operation, that is, long-pressing a paste control can remove the paste control. Alternatively, as shown in FIG. 4, after long-pressing the paste control 401, a removal symbol 403 (for example, an “x”) appears on the paste control 401, and the user can click or tap the removal symbol 403 to remove the corresponding paste control 401. In other embodiments, a paste control may be located near the boundary of one side on the interactive interface. For example, in FIG. 4, the paste control 401 is located on the upper side of the interactive interface, and the user can press the paste control and slide up to remove the paste control 401. If the paste control 401 is located on the lower side of the interactive interface, the user can press the paste control and slide down to remove the paste control 401. Embodiments of the present disclosure do not impose specific limitation on the form of the cancel operation.

When a user performs copy and paste operations, the terminal may generally set a region on the interactive interface to display paste controls. In an exemplary embodiment, the method may further include: adjusting sizes of the one or a plurality of paste controls according to the number of the one or a plurality of paste controls. Taking FIG. 3 as an example, when there is only one paste control, the width of the paste control can be appropriately increased so that more preset information can be displayed on the paste control (such as Aaxxxxxxxx . . . ). When the number of paste controls is increased, the widths of the paste controls can be appropriately reduced to make the paste controls be accommodated within the interactive interface, or the paste controls can be rearranged, for example, two rows of paste controls may be rearranged to be one row, or the spacing between paste controls may be adjusted.

Further, in an exemplary embodiment, the method may further include: when the number of the one or a plurality of paste controls exceeds a number threshold, removing corresponding paste controls from the interactive interface according to a preset mechanism. The number threshold can be set by a user or can be determined by the terminal after calculation based on the sizes of the paste controls and the interactive interface. For example, to ensure a minimum display of preset information previews in the paste control, a paste control can accommodate a minimum of two characters, and the number calculated according to the minimum size of the paste control can be the number threshold. The preset mechanism refers to a logic designed for a terminal to determine which paste control can be removed. For example, according to a FIFO (First In First Out) mechanism, the terminal records the time when each paste control is displayed on the interactive interface for the first time. When there are too many paste controls, the paste control with the earliest display time is removed. As another example, according to a LRU (Least Recently Used) mechanism, the terminal records the time when each paste control is last used. The use of each past control can include the first time the paste control is displayed on the interactive interface or the paste control is activated by the paste operation. When there are too many paste controls, the oldest paste controls are removed. In other embodiments, the function of moving multiple paste controls to change the sequence of the paste controls can be added. For example, the user can drag the paste controls to move left and right to adjust the mutual position with other paste controls, so that the user can change the priorities of the paste controls by moving the paste controls. For example, the leftmost paste control may be first removed. There may be multiple specific implementation schemes for the preset mechanism, which are not particularly limited in embodiments of the present disclosure.

In daily information processing, users often need to copy and paste information between different applications. In an exemplary embodiment, the one or a plurality of paste controls are displayed at a top layer on the interactive interface. Arranging the paste controls at a top layer means that if the paste controls are displayed on the interactive interface, when the user switches applications, the paste controls can always be displayed as they are.

It should be noted that the original contents on the interactive interface and the paste controls may block each other. This problem may be solved by using various methods. For example, a certain transparency can be set for the paste controls and the paste controls may be placed on top of the original contents, so that the original contents on the interactive interface and the paste controls both can be displayed in the same area at the same time. For another example, when displaying the paste controls, the size of the original content window can be appropriately reduced to leave a certain area for the paste controls. For another example, the paste controls can be hidden in the general state, and the paste controls are displayed again when the input state is activated. Embodiments of the present disclosure do not impose specific limitations on this.

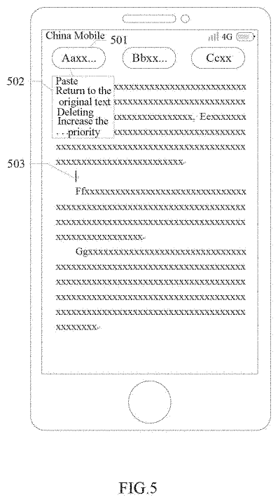

In an exemplary embodiment, the information pasting method can also be applied to a pressure-sensitive touch terminal, such as a smart phone, a tablet computer, or other device which is configured with a pressure-sensitive touch screen. In the pressure-sensitive touch terminal, a user can still implement various operations on the paste controls in the foregoing embodiments, such as dragging the paste controls to a predetermined position to implement the paste operation, long-pressing the paste controls to delete the paste controls, and so on. In addition, as shown in FIG. 5, the user can also activate an operation option box 502 of the target paste control 501 through a touch operation with varying pressure (such as the 3D touch function in some mobile phones), and select a specific option to achieve corresponding operation. The paste operation can be pasting the preset information corresponding to the paste control 501 to the selected predetermined position or the preset position 503 where the input cursor is. Returning to the original text can be returning to the original position where the preset information corresponding to the target paste control 501 is. Increasing the priority may be moving the paste control 501 to a position that is not to be removed in the paste control automatic removal queue. In addition, the operation options may include other types of operation, and are not limited to the cases shown in the figure.

In an exemplary embodiment, the preset operation may include a copy operation or a cut operation, and accordingly, the preset information may include copied information or cut information. The paste control corresponding to the cut operation can be set to be automatically removed after pasting once, or paste control corresponding to the cut operation can be set to support repeated paste use. When the terminal displays the paste controls corresponding to the copy operation and the cut operation, the two types of paste controls can be distinguished by different colors, transparencies, shapes, or other marks.

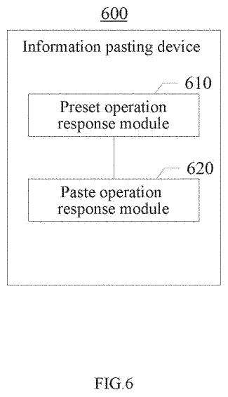

An exemplary embodiment of the present disclosure further provides an information pasting device, which can be applied to a touch terminal that presents an interactive interface. The touch terminal may be a smart phone, a tablet computer, a portable game machine, a PDA, or other device that is configured with a touch screen. The interactive interface may be an entire displayable area of the touch terminal, such as a full screen displayed on the touch terminal. Alternatively, the interactive interface may be a partial displayable area of the touch terminal, such as a window on the touch terminal. As shown in FIG. 6, the information pasting device 600 may include a preset operation response module 610 and a paste operation response module 620. The preset operation response module 610 is configured to, in response to a preset operation, display one or a plurality of paste controls on the interactive interface. The paste operation response module 620 is configured to, when a paste operation for at least one of the paste controls is received, paste preset information corresponding to the preset operation at a predetermined position on the interactive interface.

In an exemplary embodiment, the preset operation response module 610 is configured to: display a plurality of paste controls on the interactive interface, wherein any one of the plurality of paste controls corresponds to a preset operation and preset information.

In an exemplary embodiment, the information pasting device may further include a cancel operation response module configured to, when a cancel operation for the at least one of the paste controls is received, remove the at least one of the paste controls from the interactive interface.

In an exemplary embodiment, the cancel operation comprises a long-press operation.

In an exemplary embodiment, the paste operation for the at least one of the paste controls comprises: dragging the at least one of the paste controls to the predetermined position.

In an exemplary embodiment, at least a part of the preset information corresponding to the one or a plurality of paste controls is displayed in the one or a plurality of paste controls.

In an exemplary embodiment, the preset operation response module is further configured to adjust sizes of the one or a plurality of paste controls according to the number of the one or a plurality of paste controls.

In an exemplary embodiment, the preset operation response module is further configured to, when the number of the one or a plurality of paste controls exceeds a number threshold, remove corresponding paste controls from the interactive interface according to a preset mechanism.

In an exemplary embodiment, the one or a plurality of paste controls are displayed at a top layer on the interactive interface.

In an exemplary embodiment, the preset operation comprises a copy operation or a cut operation, and the preset information comprises copied information or cut information.

Details regarding the exemplary embodiments of the information pasting device can be found in the above descriptions regarding the method embodiments, and repeated descriptions are omitted here.

An exemplary embodiment of the present disclosure also provides an electronic device capable of implementing the above methods.

Those skilled in the art can understand that various aspects of the present disclosure may be implemented as a system, method, or program product. Therefore, various aspects of the present disclosure can be embodied in the following forms: a complete hardware implementation, a complete software implementation (including firmware, microcode, etc.), or a combination of hardware and software, which can be collectively referred to as “circuit”. “module”, or “system”.

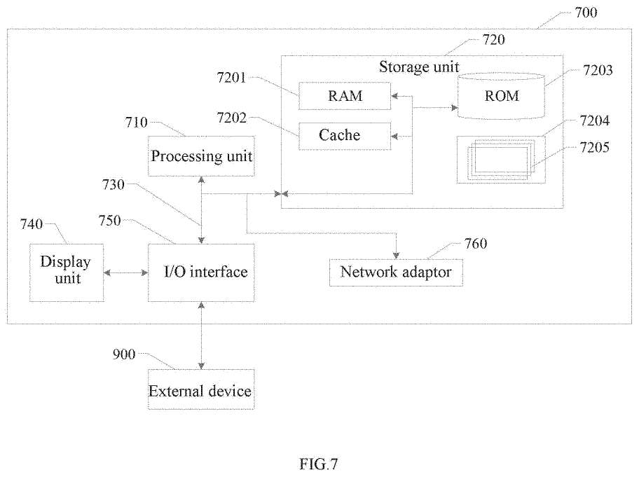

An electronic device 700 according to an exemplary embodiment of the present disclosure is described below with reference to FIG. 7. The electronic device 700 shown in FIG. 7 is only an example, and should not impose any limitation on the functions and scope of use of the embodiments of the present disclosure.

As shown in FIG. 7, the electronic device 700 is shown in the form of a general-purpose computing device. The components of the electronic device 700 may include, but are not limited to, at least one processing unit 710, at least one storage unit 720, a bus 730 connecting different system components (including the storage unit 720 and the processing unit 710), and a display unit 740.

The storage unit stores program codes, and the program codes can be executed by the processing unit 710, so that the processing unit 710 executes various exemplary embodiments according to the present disclosure described in the “exemplary methods” section of the present specification. For example, the processing unit 710 may perform the steps shown in FIG. 2. In step S210, in response to a preset operation, one or a plurality of paste controls are displayed on the interactive interface. In step S220, when a paste operation for at least one of the paste controls is received, preset information corresponding to the preset operation is pasted at a predetermined position on the interactive interface.

The storage unit 720 may include a readable medium in the form of a volatile storage unit, such as a random access storage unit (RAM) 7201 and/or a cache storage unit 7202, and may further include a read-only storage unit (ROM) 7203.

The storage unit 720 may further include a program/utility tool 7204 having a set (at least one) of program modules 7205. Such program modules 7205 include, but are not limited to, an operating system, one or more application programs, other program modules, and program data. Each or some combination of these examples may include an implementation of a network environment.

The bus 730 may be one or more of several types of bus structures, including a memory unit bus or a memory unit controller, a peripheral bus, a graphics acceleration port, a processing unit, or a local area bus using any bus structure in a variety of bus structures.

The electronic device 700 may also communicate with one or more external devices 900 (such as a keyboard, a pointing device, a Bluetooth device, etc.), and may also communicate with one or more devices that enable a user to interact with the electronic device 700, and/or may also communicate with any device (such as a router, a modem) that can enable the electronic device 700 to interact with one or more other computing devices. Such communication can be performed through an input/output (I/O) interface 750. Moreover, the electronic device 700 may also communicate with one or more networks (such as a local area network (LAN), a wide area network (WAN), and/or a public network, such as the Internet) through the network adapter 760. As shown in the figure, the network adapter 760 communicates with other modules of the electronic device 700 through the bus 730. It should be understood that although not shown in the figure, other hardware and/or software modules may be used in conjunction with the electronic device 700, including but not limited to: microcode, device drivers, redundant processing units, external disk drive arrays, RAID systems, tape drives and data backup storage systems.

Through the description of the foregoing embodiments, those skilled in the art can easily understand that the example embodiments described herein can be implemented by software, or by software in combination with necessary hardware. Therefore, the technical solutions according to the embodiments of the present disclosure may be embodied in the form of a software product, and the software product may be stored in a non-volatile storage medium (which may be a CD-ROM, a U disk, a mobile hard disk, etc.) or on a network. The software product may include instructions to cause a computing device (which may be a personal computer, a server, a terminal device, or a network device, etc.) to execute the method according to exemplary embodiments of the present disclosure.

An exemplary embodiment of the present disclosure also provides a computer-readable storage medium having stored thereon a program product capable of implementing the above methods according to embodiments of the present disclosure. In some possible implementations, aspects of the present disclosure may also be implemented in the form of a program product, which includes program codes. When the program product runs on a terminal device, the program codes are used to cause the terminal device to perform the steps according to various exemplary embodiments of the present disclosure described in the above-mentioned exemplary methods.

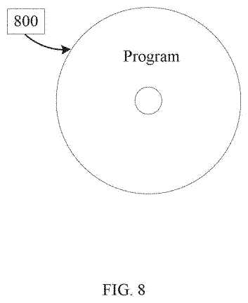

FIG. 8 shows a program product 800 for implementing the above methods according to an exemplary embodiment of the present disclosure. The program product 800 may be stored by a portable compact disc read-only memory (CD-ROM) and include program codes, and may be executed on a terminal device, such as a personal computer. However, the program product of the present disclosure is not limited thereto. The readable storage medium may be any tangible medium containing or storing a program, and the program may be used an instruction execution system, apparatus, or device, or the program may be used in combination with an instruction execution system, apparatus, or device.

The program product may employ any combination of one or more readable mediums. The readable medium may be a readable signal medium or a readable storage medium. The readable storage medium may be, for example, but is not limited to, an electronic, magnetic, optical, electromagnetic, infrared, or semiconductor system, apparatus, or device, or any combination thereof. More specific examples (non-exhaustive examples) of readable storage media include: electrical connection with one or more wires, portable disk, hard disk, random access memory (RAM), read-only memory (ROM), erasable programmable read-only memory (EPROM or flash memory), optical fiber, portable compact disc read-only memory (CD-ROM), optical storage device, magnetic storage device, or any suitable combination of the foregoing.

The computer-readable signal medium may include a data signal in baseband or propagated as part of a carrier wave, which carries readable program codes. Such a propagated data signal may have many forms, including but not limited to electromagnetic signals, optical signals, or any suitable combination of the foregoing. The readable signal medium may also be any readable medium other than a readable storage medium, and the readable medium may send, propagate, or transmit a program that is used by an instruction execution system, apparatus, or device, or that is used in combination with an instruction execution system, apparatus, or device.

The program codes contained on the readable medium may be transmitted using any appropriate medium, including but not limited to wireless, wired, optical fiber, RF, etc., or any suitable combination of the foregoing.

The program codes for performing the operations of the present disclosure can be written in any combination of one or more programming languages, which include object-oriented programming languages, such as Java, C++, and so on. The programming languages also include conventional procedural programming language, such as “C” or a similar programming language. The program codes can be executed entirely on the user computing device, can be executed partly on the user device, can be executed as an independent software package, can be executed partly on the user computing device and partly on a remote computing device, or can be executed entirely on the remote computing device or server. In the case of a remote computing device, the remote computing device can be connected to the user computing device through any kind of network, including a local area network (LAN) or a wide area network (WAN), or the remote computing device can be connected to an external computing device, for example, by the Internet provided by the Internet service providers.

In addition, the drawings are merely schematic descriptions of processes included in the methods according to exemplary embodiments of the present disclosure, and are not for limiting the present disclosure. It is easy to understand that the processes shown in the drawings do not indicate or limit the chronological order of these processes. In addition, it is also easy to understand that these processes may be performed synchronously or asynchronously in multiple modules, for example.

It should be noted that although several modules or units of the device for execution of operations are described above in detail, such division of the modules or units is not mandatory. In fact, according to exemplary embodiments of the present disclosure, the features and functions of two or more modules or units described above may be embodied in one module or unit. Conversely, the features and functions of a module or unit described above can be further divided into multiple modules or units.

Those skilled in the art will readily contemplate other embodiments of the present disclosure after considering the specification and practicing the disclosure. The present disclosure is intended to cover any variations, uses, or adaptive changes of the present disclosure. These variations, uses, or adaptive changes follow the general principles of the present disclosure and include the common general knowledge or conventional technical means in this art which is not described herein. The specification and examples should be considered as exemplary only, and the true scope and spirit of the disclosure should be defined by the appended claims.

It should be understood that the present disclosure is not limited to the precise structure that has been described above and shown in the drawings, and various modifications and changes can be made without departing from the scope of the present disclosure. The scope of the disclosure is only defined by the appended claims.

What is claimed is:

1. An information pasting method, applied to a touch terminal for presenting an interactive interface, the method comprising:
in response to a preset operation, displaying one or a plurality of paste controls on the interactive interface; and
when a paste operation for at least one of the paste controls is received, pasting preset information corresponding to the preset operation at a predetermined position on the interactive interface.

2. The information pasting method according to claim 1, wherein displaying one or a plurality of paste controls on the interactive interface comprises:
displaying a plurality of paste controls on the interactive interface, wherein any one of the plurality of paste controls corresponds to a preset operation and preset information.

3. The information pasting method according to claim 1, further comprising:
when a cancel operation for the at least one of the paste controls is received, removing the at least one of the paste controls from the interactive interface.

4. The information pasting method according to claim 3, wherein the cancel operation comprises a long-press operation.

5. The information pasting method according to claim 1, wherein the paste operation for the at least one of the paste controls comprises:
dragging the at least one of the paste controls to the predetermined position.

6. The information pasting method according to claim 1, wherein at least a part of the preset information corresponding to the one or a plurality of paste controls is displayed in the one or a plurality of paste controls.

7. The information pasting method according to claim 2, further comprising:
adjusting sizes of the one or a plurality of paste controls according to the number of the one or a plurality of paste controls.

8. The information pasting method according to claim 2, further comprising:
when the number of the one or a plurality of paste controls exceeds a number threshold, removing corresponding paste controls from the interactive interface according to a preset mechanism.

9. The information pasting method according to claim 1, wherein the one or a plurality of paste controls are displayed at a top layer on the interactive interface.

10. The information pasting method according to claim 1, wherein the preset operation comprises a copy operation or a cut operation, and the preset information comprises copied information or cut information.

11. An electronic device, comprising:
a processor; and
a memory for storing instructions executable by the processor;
wherein when the instructions are executed by the processor, the processor is caused to
in response to a preset operation, display one or a plurality of paste controls on the interactive interface; and
when a paste operation for at least one of the paste controls is received, paste preset information corresponding to the preset operation at a predetermined position on the interactive interface.

12. The electronic device according to claim 11, wherein the processor is configured to:
display a plurality of paste controls on the interactive interface, wherein any one of the plurality of paste controls corresponds to a preset operation and preset information.

13. The electronic device according to claim 11, wherein the processor is further configured to:
when a cancel operation for the at least one of the paste controls is received, remove the at least one of the paste controls from the interactive interface.

14. The electronic device according to claim 13, wherein the cancel operation comprises a long-press operation.

15. The electronic device according to claim 11, wherein the paste operation for the at least one of the paste controls comprises:
dragging the at least one of the paste controls to the predetermined position.

16. The electronic device according to claim 11, wherein at least a part of the preset information corresponding to the one or a plurality of paste controls is displayed in the one or a plurality of paste controls.

17. The electronic device according to claim 12, wherein the processor is further configured to:
adjust sizes of the one or a plurality of paste controls according to the number of the one or a plurality of paste controls.

18. The electronic device according to claim 12, wherein the processor is further configured to:
when the number of the one or a plurality of paste controls exceeds a number threshold, remove corresponding paste controls from the interactive interface according to a preset mechanism.

19. The electronic device according to claim 11, wherein the one or a plurality of paste controls are displayed at a top layer on the interactive interface.

20. The electronic device according to claim 11, wherein the preset operation comprises a copy operation or a cut operation, and the preset information comprises copied information or cut information.
